(19) United States
(12) Patent Application Publication
(10) Pub. No.: US 2015/0164277 A1
(43) Pub. Date: Jun. 18, 2015

(54) Charcoal Igniter

(71) Applicant: Dane Edward Pikkola, Portland, OR (US)

(72) Inventor: Dane Edward Pikkola, Portland, OR (US)

(21) Appl. No.: 14/536,185

(22) Filed: Nov. 7, 2014

Related U.S. Application Data
(60) Provisional application No. 61/908,592, filed on Nov. 25, 2013.

(51) Int. Cl. A47J 37/07

(52) U.S. Cl. CPC A47J 37/079

(57) ABSTRACT

The invention is a charcoal igniter 100 for cooperative use with a charcoal chimney 400. The igniter 100 having an upper portion 102 and a lower portion 116. The upper portion 102 being substantially hollow, and having a frustum shape, with the smaller diameter end being the top 106, the larger diameter being the base 110. The lower portion 116 having an ignition source reservoir for holding liquid or solid fuel that is enclosed within the upper portion's 102 hollow interior. The upper portion 103 having a top with an opening 108, and at least one air-inlet 104 being formed and shaped to meter air intake into the upper portion 102, thereby regulating the burning air-fuel mixture at the opening 108 after being lit. The upper portion 102 may further include a pre-heat ring 112 around the base 110 that is shaped to hold ignition source fuels that when lit, burn and pre-heat the upper portion 102. Further, the air-inlet 104 may be located at a height from the base 110 such that any overfilling of the lower portion 116 results in the overture being expelled in the pre-heat ring 112.

### CROSS-REFERENCE TO RELATED APPLICATION

This application claims priority under 35 U.S.C. §119(e)(1) to U.S. Ser. No. 61/908,592 filed Nov. 25, 2013, which is hereby incorporated by reference in its entirety.

### FIELD OF ART

The invention relates to igniters, and more particularly to charcoal igniters.

### BACKGROUND AND SUMMARY OF THE INVENTION

Solid fuels have been widely used to barbeque foods due to the unique flavor and aroma they imparts on the food. As used herein and to encourage consistent understanding in this disclosure, any solid fuel such as commercially produced briquettes, wood, or traditional charcoal will be referred herein collectively as “charcoal”.

In order to barbeque foods with charcoal, the charcoal needs to be ignited. Some conventional methods of igniting charcoal involve placing the charcoal in a cylindrical shaped housing commonly referred to as a chimney, dousing the charcoal with lighter fluid, standing a safe distance away, and igniting the lighter fluid vapors coming off the doused charcoal. The resulting combustion tends to be uncontrolled, but effective.

Using lighter fluid to start charcoal has many drawbacks. The lighter fluid impregnates the charcoal, and even after the charcoal is lit, the lighter fluid is often not completely expelled, or burned out before cooking temperatures are reached. Charcoal tainted with lighter fluid is generally foul smelling, often imparting the tainted smell into the food being cooked.

A cleaner and more desirable method of igniting charcoal that does not involve a petroleum based liquid involves ignition of charcoal utilizing a charcoal chimney and solid fuel as an ignition source. The ignition source may be of any suitable materials, such as crumpled paper or foraged fuels such as splinters of wood, which are enclosed by the chimney under the charcoal. The ignition source once ignited, burns with unregulated air entering through the holes in the sides of the chimney. Unregulated air causes the ignition to be susceptible to wind, makes for an inefficient combustion, often resulting in an inconsistent flame that burns at a relatively low temperature, at a short height. This method of charcoal ignition using solid fuels in cooperation with a chimney avoids the problems involving foul smelling petroleum based fuels, but does not provide a method or apparatus that quickly and reliably ignites the charcoal within the chimney.

Various lighting methods and apparatuses for charcoal ignition are well known in the barbeque arts as described above, but the use of alcohol based liquid fuels as a charcoal ignition source for a chimney charcoal ignition is not. Examples of early alcohol burning apparatus used for stove applications are disclosed by U.S. Pat. No. 466,867 to Wojidkow, U.S. Pat. No. 599,147 to Manning, et al., U.S. Pat. No. 1,036,523 to Lange, U.S. Pat. No. 1,130,501 to Erichsen, U.S. Pat. No. 3,316,957 to Stokli, et al., U.S. Pat. No. 3,606,609 to Lipper, et al., and U.S. Pat. No. 4,793,321A to Rafford, et al. The alcohol burning stove configurations described above are intended for open air cooking, and are adapted to address the specific problems associated with cooking outdoors with alcohol. They are not constructed nor functionally adaptable for the specialized application of pre-heating charcoal and igniting the same while enclosed in a cylindrical chimney.

The unique challenges presented when using an alcohol burner within the confines of a charcoal chimney for starting charcoal that are not addressed nor resolved in the prior art, which include:
a. No tuning the flame: The user cannot change air inlet draft adjustments while the igniter is in the chimney;
b. Not getting the charcoal hot enough to ignite: The substantial mass of the charcoal requires considerable thermal energy input before ignition;
c. Failing to overcome the significant thermal losses of the chimney: The relatively large cylinder body of the chimney dissipates thermal energy quickly over a large surface area essentially causing a heat sink effect wherein the chimney is cooling the charcoal while the burner is trying to heat it up;
d. Unable to ignite all of the charcoal at the same time: The vertical stacking of the charcoal within the chimney makes the centrally located lower charcoal closest to the burner susceptible to premature ignition, while the charcoal located along the cylinder wall prove susceptible to slow or incomplete ignition.

To overcome these unresolved challenges the inventive igniter is specially adapted to cooperatively work with the chimney structure to quickly, effectively, and completely ignite the charcoal contained therein. To accomplish this, the ignition of the charcoal is performed in two burning phases that occur after the chimney is placed over the burning igniter.

A first burning phase involves a relatively large circumferentially oriented flame that burns around the igniter substantially paralleling the walls of the chimney. The chimney interior effectively defines a pseudo combustion chamber surrounding the igniter enclosing the first phase of the burn thereby causing a slight increase in pressure within the chimney interior that encourages the expanding gasses to flow up, through the charcoal and out of the chimney top. The chimney, charcoal, igniter and ignition source are heated up together which encourage directional drafting of cool air into the chimney bottom to feed the burn. Alcohol based fuels tend not vaporize well at lower temperatures, and the chimney interior provides the contained combustion needed to initially heat up the ignition source adequately for vaporization and gas flow within in the igniter to facilitate a second phase of burning that concentrates the flame into the charcoal.

A second burning phase involves a controlled flame projecting from the igniter that is centrally located below the charcoal within the chimney that burns the pre-heated fuel held in a reservoir in the bottom of the igniter. At least one air inlet through the igniter's side wall meters the air that enters the igniter body, thereby regulating the burn rate, intensity, and heating characteristics of the flame that projects through the top. The resulting second phase burn flames longer than the first phase, is tailored to reach the center of charcoal mass with the top sections of the flame, which are the hottest. The second phase of burning continues burning until all of the ignition source in the reservoir is expended.

As discussed, the prior art is replete with various versions of simple burners that successfully combust the vapors of alcohol. However, prior art alcohol burners are designed to address the specific problems associated with open air cooking or heating. They are not designed nor prove adaptable to igniting charcoal within a chimney. Prior inventions involving alcohol burners do not conceive of an alcohol igniter that is suited for internal use within a pseudo combustion chamber as defined by the chimney interior. Nor are there teachings or suggestions of a multi-phase burn feature that overcomes the challenges of igniting charcoal in a cold chimney.

The primary object of the invention is to provide an apparatus of the kind referred to herein that functionally cooperates with the chimney structure to provide an improved charcoal ignition.

Another object of the invention is to provide an igniter that burns a clean and non-tainting ignition source, such as denatured alcohol, grain alcohol, or other suitable alcohol based fuels.

It is a further object of the invention to provide an ignition apparatus that has reliable function, even in cold temperatures.

Other objects and advantages of the invention will become obvious to one skilled in the art upon review of this specification. The charcoal igniter comprises the features of construction, combinations of elements, and arrangement of parts which will be exemplified in the constructions hereinafter set forth, and the scope of the invention will be provided for in the claims.

### BRIEF DESCRIPTION OF THE DRAWING

FIG. 1 illustrates a charcoal igniter according to one embodiments of the present disclosure.

FIG. 2 illustrates a lower portion of the embodiment in FIG. 1.

FIG. 3 is a cross-sectional view of the embodiment in FIG. 1.

FIG. 4 is a view of the embodiment in FIG. 1 being utilized in conjunction with a charcoal chimney.

### DETAILED DESCRIPTION OF THE DRAWING

The present disclosure describes an apparatus and method for igniting charcoal in a chimney. For purposes of explanation, specific numbers, materials and configurations are set forth in order to provide an enabling understanding of the invention. In the following detailed description, reference is made to the accompanying drawings of one of many embodiments, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. The following detailed description is not to be taken in a limiting sense, and the scope of embodiments is defined by the appended claims and their equivalents. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). The description may use perspective based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

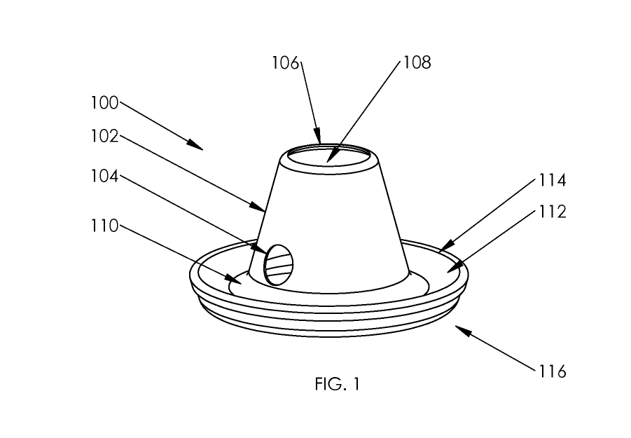

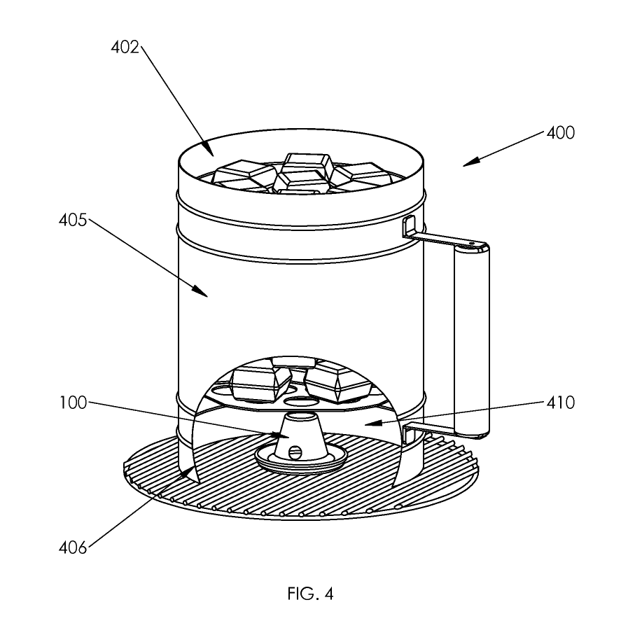

As illustrated in FIGS. 1-4, the preferred embodiment of the charcoal igniter 100 is specifically suited for cooperative use within a charcoal chimney 400, the charcoal chimney 400 having an elongated tubular housing with an interior and an exterior surface therein charcoal 402 is held within the upper interior 405 and a combustion chamber 410 is defined by the lower interior 406 under the charcoal 402. The charcoal igniter 100 is specially suited to cooperatively burn within the combustion chamber 410 for improved ignition of the charcoal 403 located there above. The charcoal igniter 100 has an upper portion 102 and a lower portion 116. The upper portion 102 being hollow, and having a frustum shape, with the smaller diameter end being the top 106, the larger diameter being the base 110, and a sidewall 109 there between. The lower portion 116 having a reservoir 117 for holding the ignition source fuels that are enclosed within the upper portion's 102 interior. The upper portion 103 having a top with at least one opening 108, and at least one air-inlet 104, the air-inlet 104 being formed and shaped to meter air intake into the upper portion 102, thereby regulating the second phase of the burn as discussed herein. The upper portion 102 further includes a pre-heat ring 112 around the base 110 that is shaped to hold ignition source fuels that when lit, burns within the combustion chamber 410 depicted in FIG. 4. Once ignited, the pre-heat ring 112 burns contained within the combustion chamber 410 with the heated gases therein increasing pressures slightly within the combustion chamber 410 encouraging upward flow through the charcoal 402 and out of the chimney 400 top. The flowing gasses heat up the charcoal chimney 400, the charcoal 402, the igniter 100, and the ignition source fuel held within the reservoir 117.

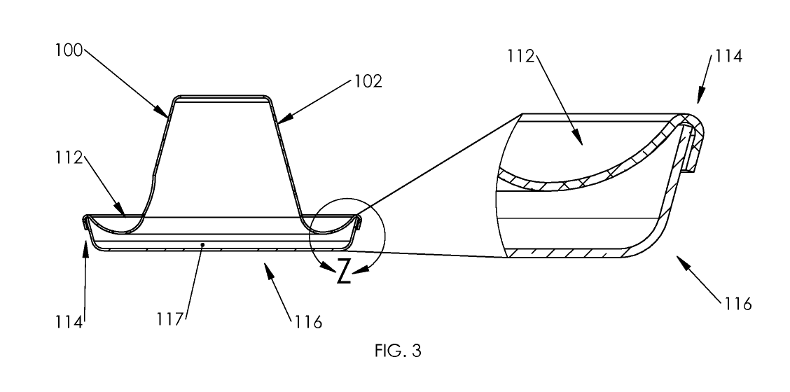

The charcoal igniter 100 as shown in FIGS. 1 and 3, has an upper portion 102 that covers and lips over the outer edge 114. In other embodiments, the upper portion 102 is constructed having a smaller diameter at the base 110 than the lower portion 116, and the pre-heat ring 112 is formed in the lower portion 116 rather than the upper portion 102. In other embodiments the upper portion 102 may be constructed and arranged with the lower portion 116 such that the lower portion 116 has the pre-heat ring 112 integrally formed. The air-inlet 104 is located at a preferred height from the base 110 such that any overfilling of the lower portion 116 results in the overture being expelled in the pre-heat ring 112 thereby avoiding any waste of ignition source fuel. As used herein, frustum refers to the portion of a three-dimensional geometric shape that lies between first and second parallel planes that truncate the geometric shape and where the first and second parallel planes define a top and a base, respectively, the top being smaller in size relative to the base. The frustum shape as depicted is conical, or frustoconical, but in other embodiment could be of other suitable shape such as pyramidal. As discussed above, the first and second parallel planes of the frustum shaped portion creates a top 106 and a base 110.

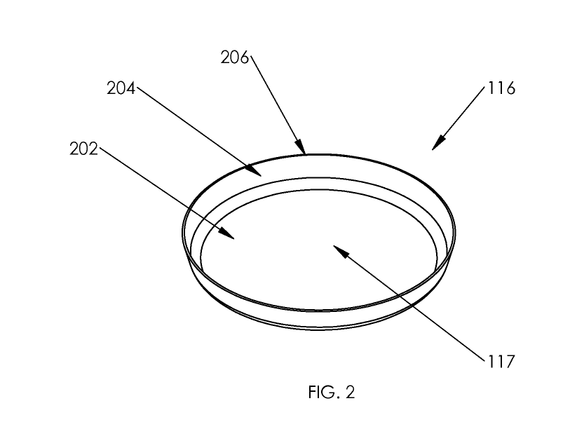

FIG. 2 illustrates the lower portion 116 according to the preferred embodiments having a bottom surface 202 with a side 204 extending vertically from the bottom surface to form a vessel configured as a reservoir 117 for the ignition source, or fuel. The side 204 may have a lip 206 configured to attach to upper portion 102 of FIG. 1, as described above. The top 106 of the upper portion 102 having an opening 108 through which ignition source fuel is poured pre-ignition into the reservoir 117 area depicted in FIG. 2. within the lower portion 116.

As depicted in FIGS. 1 and 3, the upper portion 102 has one opening 108 at the top 106, and at least one air-inlet 104 located on the side of the upper portion 102 oriented closer to the base 116 than the top 106. Ignition source may be poured in either of these opening to fuel the charcoal igniter 100. The air-inlet 104 is oriented to be in air communication with the reservoir 117, and sized to meter the desired amount of air that flows to the interior of the upper portion 102 that mixes with ignition source vapors before exiting the opening 108 to be burned in the combustion chamber. The larger the air-inlet 104, the more air introduced into the interior of the upper portion 102. The air-inlet 104 is sized and shaped to regulate within the combustion chamber 410 the desired flame characteristics for lighting the charcoal 402 within the charcoal chimney 400. The air-inlet 104 is also located at the maximum ignition source fill line, such that any over-filling results in the overture flowing out of the air-inlet 104 to be captured in a pre-heat ring 112.

As shown in FIGS. 1 and 3, the pre-heat ring 112 extends radially around the base 110 and is shaped to be suitable for holding liquid fuel around the entire circumference of the upper portion 102. Once lit, the first phase of charcoal ignition begins, and the burning fuel held in the pre-heat ring 112 contained within the combustion chamber 410 results in a localized confined combustion that slightly raises the gas pressures within the chimney 400 while pre-heating the charcoal chimney 400, the charcoal 402, the charcoal igniter 100, and the ignition source fuel contained therein. Pre-heating the charcoal chimney 400 encourages hotter gas flow which improves vaporization of the ignition source fuel, while further urging air to be drawn into the bottom of the chimney 400 to pass through the air-inlet 104 to mix with the vaporized fuel within the upper portion 102. In this way, the flow of heated gases in the chimney 400 expedites the flow of gasses out of the opening 108, causing a quicker ignition of the second phase burn, resulting in faster charcoal 402 ignition. The second phase burn causes further drafting through the air-inlet 104 which effectively pulls the flame from the pre-heat ring 112 into the upper portion 102 interior, thereby changing a first phase relatively large omnidirectional, to a second phase tall intense flame that projects heat into the charcoal 402 mass within the charcoal chimney 400.

As discussed above, the pre-heat ring 112 may have an outer edge 114 that fixated the upper portion 102 to lower portion 116. Permanent fixation may be accomplished, for example, by crimping, welding, or otherwise coupling outer edge 114 to lower portion 116. In some embodiments, lower portion 116 and upper portion 102 may be attached together utilizing interlocking threads such that the lower portion 116 may be screwed together with outer edge 114 threadingly connecting to the lower portion 116. In further embodiments, upper portion 102 and lower portion 116 may be attached to one another through a hinge and/or buckle system, not pictured. In still other embodiments the upper portion 102 may merely rest on lower portion 116. As depicted in FIGS. 1-4, the upper portion 102 and/or lower portion 116 may be constructed from various materials including, but not limited to metal, ceramic, or any combination thereof. These materials may be selected independently for upper portion 102 or lower portion 116. Possible metals include, but are not limited to, brass, stainless steel, aluminum, or cast iron. The materials selected may be dependent upon the intended usage of charcoal igniter 100. For instance, in some embodiments, a charcoal igniter may be designed for a single usage and an appropriate material in these embodiments may be a lightweight aluminum. In other embodiments, the charcoal igniter may be reusable and a more durable material such as stainless steel, cast iron or ceramic clay may be used. In embodiments, where the charcoal igniter is for a single usage, charcoal igniter 100 may come pre-loaded with an appropriate ignition source, such as one of the ignition sources discussed below. In embodiments where charcoal igniter 100 comes pre-loaded with an ignition source, the ignition source may be a liquid or gelled ignition source and charcoal igniter 100 may be pre-loaded with as little as 6 milliliters (ml) of the ignition source, which may be sufficient for single use ignition of charcoal due to the frustum shape of upper portion 102 which acts to concentrate the flame created by combustion of the ignition source.

In some embodiments, the upper portion and/or lower portion may be coated with a heat sensitive coating which may change color when heat is applied. Such a coating may make it easier to see when charcoal igniter 100 is hot. This may make it easier to avoid inadvertent burns caused by a hot charcoal igniter 100 and may also be an indicator of when the charcoal igniter has reached an optimal temperature for igniting the charcoal. In other embodiments, no exterior coating or finish may be necessary.

As used herein, ignition source may refer to any type of fuel capable of igniting charcoal such as alcohol. Alcohol fuels include, for example, methanol, ethanol, butanol and/or denatured alcohol. In embodiments, the alcohol based fuel may be in liquid form or may be a gelled alcohol based fuel. A gelled fuel may be beneficial in the event of accidental tipping of charcoal igniter 100 where liquid alcohol may spill, a gelled alcohol may be resistant to spilling. In some embodiments, a dye may be added to a liquid fuel. Such a dye may help ensure that the fuel is easily identifiable as a fuel and not mistaken for another liquid, such as water. In some embodiments, approximately 6 milliliters (ml) of fuel may be sufficient to consistently ignite a portion of charcoal placed above charcoal igniter 100 due to the frustum shape of upper portion 102 which may act to concentrate the flame created by combustion of the ignition source.

FIG. 3 is a cross-sectional view of a charcoal igniter 100 according to some embodiments of the present disclosure. As depicted, upper portion 102 is configured to be positioned above and secured onto the lower portion 116. The pre-heat ring 112 may have outer edge 114 formed around the perimeter of pre-heat ring 112. Outer edge 114 may be rolled over to provide for a means to secure attachment with lower portion 116. As discussed above, in one embodiment, upper portion 102 may be attached to lower portion 116 by crimping outer edge 114 over the lip of lower portion 116. While charcoal igniter 100 is depicted herein as two separate pieces, upper portion 102 and lower portion 116, it will be appreciated that in some embodiments, upper portion 102 and lower portion 116 may be manufactured as a single piece. Alternatively, more than two pieces could be used in certain embodiments, and the lower portion 116 may include the pre-heat ring 112 rather than the upper portion 102 as shown in FIGS. 1-4.

FIG. 4 is a view of a charcoal igniter 100 according to some embodiments of the present disclosure incorporated with a charcoal chimney 400. As depicted, charcoal igniter 100 may be incorporated with charcoal chimney 400. In some embodiments, the charcoal chimney 400 may include a confined combustion chamber 410 with adjustable air holes to reduce the charcoal igniter's 100 pre-heat time. In some embodiments, charcoal chimney 400 and charcoal igniter 100 may be adapted to attach to one another and thus form a single unit. For example, charcoal chimney may have a ring affixed below charcoal 402 configured to integrate with the structure of the charcoal igniter by way of interlocking threads, set screws, machine screws, heat resistant adhesive, weld, etc.

These examples are merely for illustrative purposes and are not to be limiting. Any known method of affixing charcoal igniter 100 to charcoal chimney 400 is contemplated by this disclosure.

The above description of illustrated implementations, including what is described in the Abstract, is not intended to be exhaustive or to limit the embodiments of the present disclosure to the precise forms disclosed. While specific implementations and examples are described herein for illustrative purposes, various equivalent modifications are possible within the scope of the present disclosure, as those skilled in the relevant art will recognize. These modifications may be made to embodiments of the present disclosure in light of the above detailed description. The terms used in the following claims should not be construed to limit various embodiments of the present disclosure to the specific implementations disclosed in the specification and the claims. Rather, the scope is to be determined entirely by the following claims, which are to be construed in accordance with established doctrines of claim interpretation.

What is claimed is:

1. A charcoal igniter 100 for cooperative use within a charcoal chimney 400 for the lighting of charcoal 403 held therein using an ignition source, the improvement comprising:
a charcoal igniter 100 being of shape and size to fit within a charcoal chimney 400, the charcoal igniter 100 having an upper portion 102 and a lower portion 116;
the upper portion 102 having a top 106, a base 110, and a side wall 109, the side wall 110 extending between the top 106 and the base 110;
the lower portion 116 having a reservoir 117 constructed and arranged to contain the ignition source within the upper portion 102;
the top 106 having a smaller diameter than the base 110 with at least one opening 108 that is in air communication with the reservoir 117;
the base 110 having a pre-heat ring 112 constructed and arranged to hold the ignition source circumferentially around the side wall 109; and
the sidewall 109 having at least one air-inlet 104 in air communication with the reservoir 117.

2. As claimed in claims 1, wherein at least one air-inlet 104 is located closer to the base 110 than the top 106, such that when the reservoir 117 is overfilled, the ignition source liquid flows out of the air-inlet 104 and into the pre-heat ring 112.

3. A charcoal igniter according to claim 1, wherein the upper portion 102 and the lower portion 116 are integrally formed.

4. A charcoal igniter according to claim 1, wherein the ignition source comprises alcohol.

5. A charcoal igniter according to claim 1, wherein the charcoal chimney 400 and charcoal igniter 100 are integrally formed.

6. A charcoal igniter according to claim 1, wherein the upper portion 102 is conically shaped and hollow.
